(19) United States
(12) Patent Application Publication
(10) Pub. No.: US 2016/0202736 A1
(43) Pub. Date: Jul. 14, 2016

(54) Hinge Device and Hinge Main Body

(71) Applicant: Acer Inc., New Taipei City (TW)

(72) Inventors: Yi-Ta Huang, New Taipei City (TW); Wen-Chieh Tai, New Taipei City (TW); Cheng-Nan Ling, New Taipei City (TW); Hsien-Wei Chen, New Taipei City (TW); Chun-I Chen, New Taipei City (TW)

(21) Appl. No.: 14/751,197

(22) Filed: Jun. 26, 2015

(30) Foreign Application Priority Data
Jan. 8, 2015 (TW) 104100476

(51) Int. Cl. G06F 1/16; E05D 5/14; E05D 3/06

(52) U.S. Cl. CPC G06F 1/1681; E05D 3/06; E05D 5/14

(57) ABSTRACT

A hinge device with a plurality of hinge main bodies and a plurality of connecting parts is disclosed. Each hinge main body aligns along a first direction and has two connecting shafts and a connecting portion. The two ends of the connecting portion connect to the two connecting shafts. Each connecting part is located between the hinge main bodies and respectively connected to the connecting shafts of different hinge main bodies such that each hinge main body can turn to multiple angles relative to each connecting part.

### BACKGROUND OF THE INVENTION

1. Field of the Invention

The present invention relates to a hinge device; more particularly, the present invention relates to a hinge device which can turn to multiple angles.

2. Description of the Related Art

In the current development of hinge devices which are applied to electronic products, the current mainstream design uses a single axis or a biaxial hinge to connect components of the electronic product (e.g., the main unit and display panel of a notebook computer) via a shaft connection method, such that the electronic product can be opened or closed. However, this kind of hinge device only allows the electronic product to be opened or closed simply; as applications of the electronic product become various and the user has more expectations of the functions of electronic products, electronic products which can only be opened or closed fail to meet the expectations and needs of the user. Therefore, there is a need to develop a hinge which can turn to multiple angles to increase the adjustability of the electronic product, which can not only solve the problem of the prior art but also increase the willingness of the user to buy this kind of electronic product.

### SUMMARY OF THE INVENTION

It is an object of the present invention to provide a hinge device which can turn to multiple angles.

To achieve the abovementioned object, the hinge device of the present invention includes a plurality of hinge main bodies and a plurality of connecting parts, wherein each hinge main body aligns along a first direction, and each hinge main body includes two connecting shafts and a connecting portion. The two ends of the connecting portion are respectively connected to the two connecting shafts. Each connecting part is located between each of the hinge main bodies, and each connecting part is respectively connected to the neighboring connecting shaft of a different hinge main body such that each hinge main body can turn to multiple angles relative to each connecting part.

Therefore, the present invention uses the connecting part to connect the neighboring connecting shafts of different hinge main bodies such that the whole hinge device of the present invention can achieve various and fine turning angles so as to increase the adjustability of the electronic product which uses the hinge device of the present invention.

The present invention also provides another hinge main body; the hinge main body includes two connecting shafts, a plurality of connecting portions and a plurality of holes. The two connecting shafts are parallel to each other. The two ends of the connecting portion are respectively connected to the two connecting shafts.

Each hole is respectively located between the two neighboring connecting portions. In addition, the abovementioned hinge main body is connected to the plurality of connecting parts, wherein each connecting part is located between each hinge main body, and each connecting part is respectively connected to the neighboring connecting shaft of a different hinge main body such that each hinge main body can turn to multiple angles relative to each connecting part.

### BRIEF DESCRIPTION OF THE DRAWINGS

FIG. 1 illustrates an exploded drawing of the hinge device of one embodiment of the present invention.

FIG. 2 illustrates a combination schematic drawing of the hinge device of one embodiment of the present invention.

FIG. 3 illustrates another combination schematic drawing of the hinge device of one embodiment of the present invention.

FIG. 4 illustrates an actuation schematic drawing of the hinge device of one embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

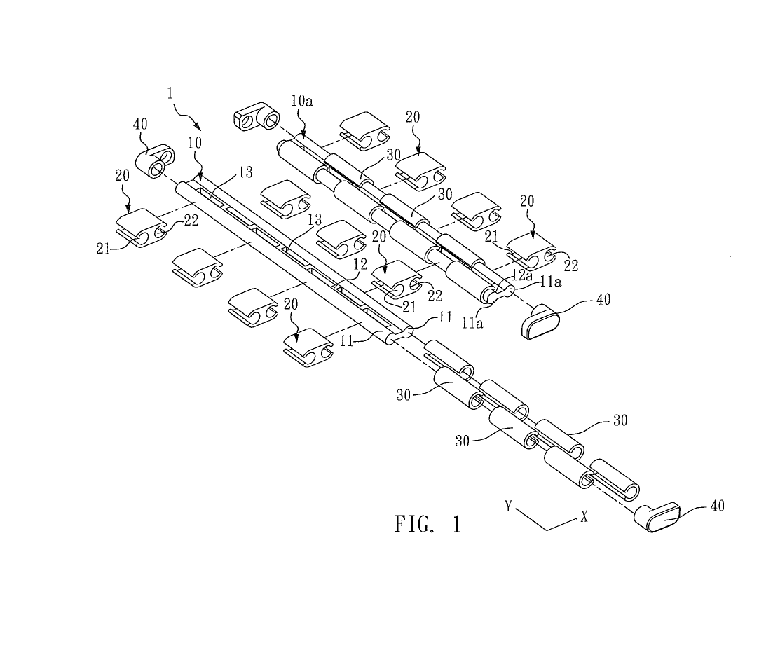

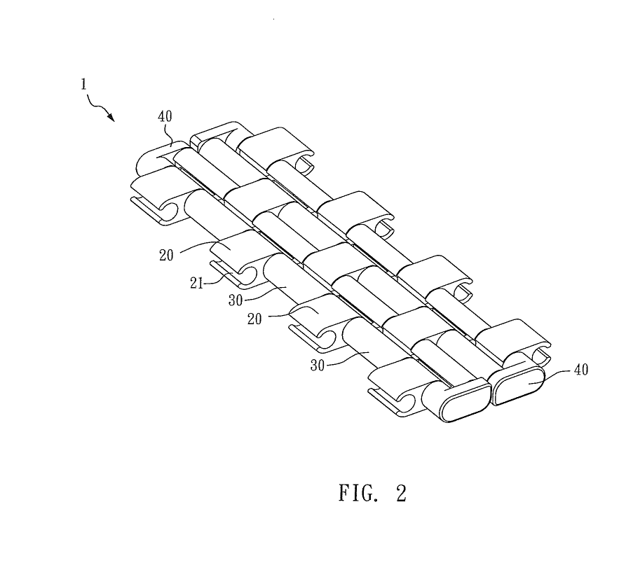

Please refer to FIG. 1 to FIG. 4, which present the exploded drawing, the combination schematic drawings and the actuation schematic drawing of the hinge device of the present invention.

The hinge device 1 of the present invention can be used as a rotation hinge of an electronic device or a display device (not shown in the figure) for allowing the user to adjust the display/viewing angle or the using angle of the electronic device. In one embodiment of the present invention, the electronic device can be a flexible monitor, a tablet computer or other electronic device which can be turned to multiple angles, but the present embodiment is not limited to the above examples.

As shown in FIG. 1, according to one embodiment of the present invention, the hinge device 1 of the present invention includes a plurality of hinge main bodies 10, a plurality of connecting parts 20, a plurality of separating parts 30 and a plurality of protection covers 40, wherein each hinge main body 10 is parallel to another and aligned along a first direction X; the two opposite ends of each connecting part 20 are connected to the different hinge main bodies—10 to form a connection—between the two neighboring hinge main bodies 10, allowing each hinge main body 10 to turn relative to each connecting part 20. According to one embodiment of the present invention, the separating part 30 is located between two neighboring connecting parts 20, and the protection covers 40 are respectively located at two opposite ends of each hinge main body 10.

It is to be known that, as shown in FIG. 1 to FIG. 3, according to the size of the electronic device which incorporates the hinge devices 1, 1a, the numbers of the hinge main bodies 10 and the connecting parts 20 of the hinge devices 1, 1a can be adjusted. To describe the detailed connecting relation of each of the elements of the hinge devices 1, 1a of the present invention, the hinge device 1 is formed via the combination of two hinge main bodies 10, 10a in this embodiment, but the present invention is not limited to that design.

As shown in FIG. 1, the hinge main body 10 includes two connecting shafts 11, at least one connecting portion 12 and a plurality of holes 13, wherein the two ends of the connecting portion 12 are respectively connected to the connecting shaft 11, and the connecting shaft 11 can extend along the second direction Y to determine the whole length of the hinge main body 10 according to the size of the electronic device. The structure of the hinge main body 11a is the same as the structure of the hinge main body 10; i.e., the hinge main body 11a includes two connecting shafts 11a, at least one connecting portion 12a and a plurality of holes (not shown in the figure). It is to be known that, in the present embodiment, the two connecting shafts 11 of the same hinge main body 10 are only partially connected via the plurality of connecting portions 12, the plurality of holes 13 are staggered and divergently located between the two connecting shafts 11, and the second direction is perpendicular to the first direction. Furthermore, the plurality of connecting portions 12 are the portions between the two connecting shafts 11 without the holes 13 in FIG. 1, but the number of the connecting portions 12 of the same hinge main body 10 can also be one; however, the present invention is not limited to this embodiment. The structure and the function of the hinge main body 11a are the same as those of the hinge main body 11, so there is no need for furthermore description.

As shown in FIG. 1, in the present embodiment, the two hinge main bodies 10, 10a, the plurality of connecting parts 20 are located between the hinge main bodies 10, 10a and located alternately along the second direction Y. Meanwhile, in the present embodiment, each connecting part 20 includes a first connecting portion 21 and a second connecting portion 22, wherein the first connecting portion 21 and the second connecting portion 22 are individually located at the two opposite ends of the connecting part 20, allowing the first connecting portion 21 and the second connecting portion 22 to respectively connect to the two neighboring connecting shafts 11, 11a of the different hinge main bodies 10 to form the connection of the two neighboring hinge main bodies 10. In the present embodiment, the first connecting portion 21 and the second connecting portion 22 are shaped as an arc for connecting to the corresponding connecting shafts 11, 11a.

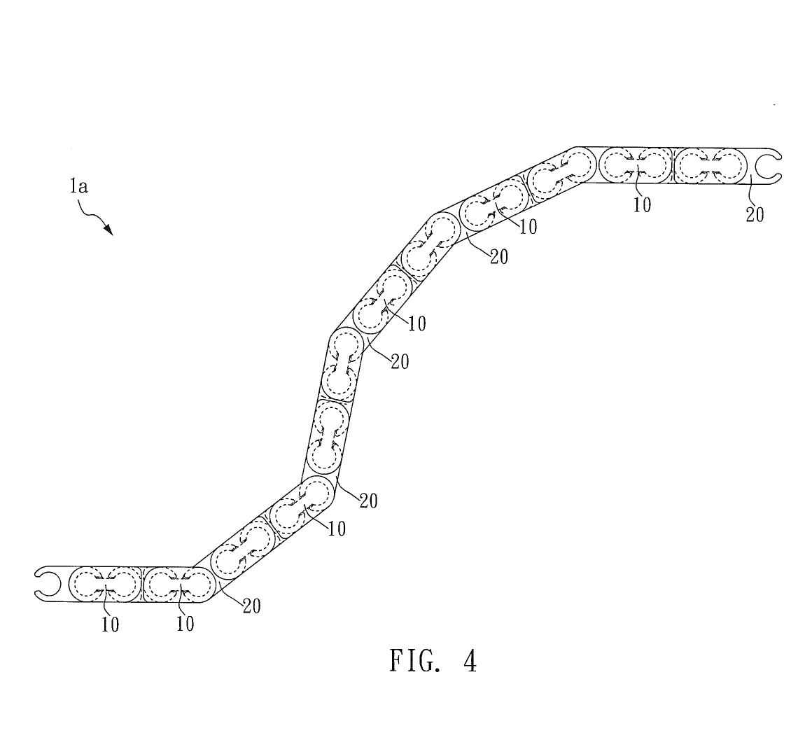

Furthermore, as shown in FIG. 4, the hinge device 1 of the present invention uses the interference between the connecting shaft 11 and the corresponding first connecting portion 21 or the second connecting portion 22 to make the hinge main body 10 turn relative to the corresponding connecting part 20.

It is to be known that the number and size of the connecting parts 20 for connecting the two hinge main bodies 10, 10a can be changed according to various product specifications or the design requirements of the electronic device which incorporates the hinge device of the present invention. The interference between the connecting shaft 11 and the first connecting portion 21 or the second connecting portion 22 can also be changed by changing the aperture size of the first connecting portion 21 and the second connecting portion 22 to increase the resistance to rotation of the hinge device 1 of the present invention, but the present invention is not limited to the abovementioned embodiment. Furthermore, if the setting amount of the hinge main bodies 10 is more than two, as shown in FIG. 1 to FIG. 3, the connecting parts 20 will be aligned along the first direction X and the second direction Y at the same time; at this moment, each connecting part 20 will be connected to the neighboring connecting shafts 11 of the different hinge main bodies 10 to form hinge devices 1, 1a of different sizes.

Please refer to FIG. 1 again; the plurality of holes 13 of the hinge main body 10 are discrete and located alternately between the two connecting shafts 11, and the position of the hole 13 is corresponded to the connecting part 20, such that when each hinge main body 10 turns relative. to the connecting part 20, each hole 13 provides an actuation space for each corresponding first connecting portion 21 or each second connecting portion 22. As shown in FIG. 1, in the present embodiment, the plurality of separating parts 30 are divergently located on the connecting shaft 11 along the second direction Y, and each of the separating parts 30 is located between the two neighboring first connecting portions 21 or the second connecting portions 22 to help to position each connecting part 20 aligned along the second direction Y and thereby to prevent each connecting part 20 from slipping and shifting on the connecting shaft 11.

As shown in FIG. 1, during assembly of the hinge device 1 of the present invention, the connecting part 20 and the separating part 30 can be individually slid from one end of the connecting shaft 11, and the protection covers 40 can be placed to cover the two ends of the hinge main bodies 10, 10a. In the present embodiment, as shown in FIG. 1, the protection covers 40 are respectively located at the two opposite ends extended from each hinge main body 10, 10a along the second direction Y to prevent removal of the connecting part 20 and the separating part 30 located on the connecting shaft 11, and to complete the assembly of the hinge device 1 of the present invention.

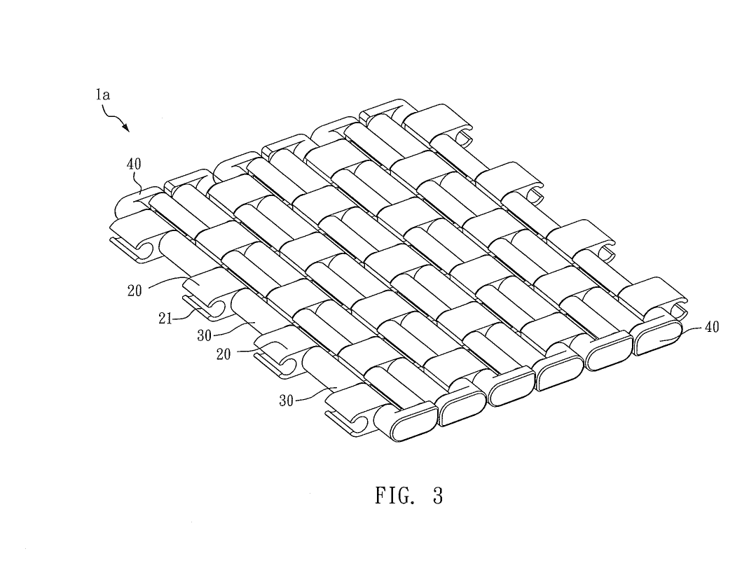

As shown in FIG. 3 and FIG. 4, after the hinge device 1a of the present invention is assembled completely, the connecting shaft 11 of each hinge main body 10 is connected to the different connecting parts 20 such that when the hinge main body 10 turns relative to the connecting part 20, via the interference between each connecting shaft 11 and the corresponding first connecting portion 21 or the second connecting portion 22, each hinge main body 10 will be interlocked such that the whole hinge devices 1, 1a of the present invention can achieve various and fine turning angles to increase the applicability and the plasticity of the hinge devices 1, 1a of the present invention.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the spirit and scope of the invention.

What is claimed is:

1. A hinge device comprising:
a plurality of hinge main bodies, wherein each of the hinge main bodies is aligned along a first direction, and each of the hinge main bodies comprises two connecting shafts and a connecting portion, the two ends of the connecting portion being respectively connected to the two connecting shafts; and
a plurality of connecting parts, wherein each of the connecting parts is located between each of the hinge main bodies, each of the connecting parts being respectively connected to the neighboring connecting shaft of the different hinge main bodies such that each of the hinge main bodies can turn to multiple angles relative to each of the connecting parts.

2. The hinge device as claimed in claim 1, wherein each of the connecting parts comprises a first connecting portion and a second connecting portion, each of the first connecting portions and each of the second connecting portions being respectively connected to the neighboring connecting shaft of different hinge main bodies to form a connection of the two neighboring hinge main bodies.

3. The hinge device as claimed in claim 2, wherein each of the hinge main bodies comprises a plurality of holes, each of the holes being located divergently between the two connecting shafts, and a position of each of the holes being corresponded to each of the connecting parts, such that when each of the hinge main bodies turns relative to each of the connecting parts, an actuation space is provided for each of the first connecting portions or each of the second connecting portions.

4. The hinge device as claimed in claim 1, wherein the two connecting shafts extend along a second direction which is perpendicular to the first direction.

5. The hinge device as claimed in claim 4, wherein each of the connecting parts is arranged along the first direction and the second direction at the same time, and each of the connecting parts is respectively connected to the neighboring connecting shaft of a different hinge main body.

6. The hinge device as claimed in claim 5, wherein the hinge device comprises a plurality of separating parts, each of the separating parts being located divergently in each of the connecting shafts along the second direction and located between the two neighboring connecting parts.

7. The hinge device as claimed in claim 1, wherein the hinge device comprises a plurality of protection covers, each of the protection covers being respectively located at the two opposite ends of each of the hinge main bodies.

8. A hinge main body, comprising:
two connecting shafts, wherein the two connecting shafts are parallel to each other;
a plurality of connecting portions, wherein the two ends of each of the connecting portions are respectively connected to the two connecting shafts; and
a plurality of holes, wherein each of the holes is located divergently between the two neighboring connecting portions.

9. A hinge device, comprising:
a plurality of hinge main bodies as claimed in claim 8; and
a plurality of connecting parts, wherein each of the connecting parts is located between each of the hinge main bodies, and each of the connecting parts is respectively connected to the neighboring connecting shaft of another hinge main body such that each of the hinge main bodies can turn to multiple angles relative to each of the connecting parts.

10. The hinge device as claimed in claim 9, wherein a position of each of the holes is corresponded to each of the connecting parts, such that when each of the hinge main bodies turns relative to each of the connecting parts, an actuation space is provided for each of the connecting parts.
